(19) United States
(12) Patent Application Publication
(10) Pub. No.: US 2007/0281735 A1
(43) Pub. Date: Dec. 6, 2007

(54) Remote communication device for wireless system

(76) Inventor: Hideaki Suzuki, Nagoya-city (JP)

Correspondence Address: HARNESS, DICKEY & PIERCE, P.L.C., P.O. BOX 828, BLOOMFIELD HILLS, MI, 48303, US

(21) Appl. No.: 11/093,164

(22) Filed: Mar. 29, 2005

(30) Foreign Application Priority Data
Mar. 30, 2004 (JP) 2004-99738

(51) Int. Cl. H04M 1/00

(52) U.S. Cl. 455/551

(57) ABSTRACT

A remote communication apparatus having a wireless communication function for intermediating a call of a registered cellular phone decreases a connection area for the wireless communication function under an instruction from a user of the cellular phone, and issues a temporary registration number for a non-registered cellular phone for accommodating the wireless communication function for the call to/from the non-registered cellular phone. In this manner, the remote communication apparatus uses fewer steps of registration operation to register a non-registered cellular phone.

### CROSS REFERENCE TO RELATED APPLICATION

This application is based on and incorporates herein by reference Japanese Patent Application No. 2004-99738 filed on Mar. 30, 2004.

### FIELD OF THE INVENTION

The present invention generally relates to a remote communication device for wireless system having an intermediation function by a wireless connection.

### BACKGROUND OF THE INVENTION

A conventional remote communication apparatus is used to assist a driver of a vehicle for answering a call to a cellular phone when the driver is mainly involved in driving of the vehicle. The remote communication apparatus intermediately relays an audible signal of a cellular phone in communication with a telephone to a user of the cellular phone. That is, the remote communication apparatus outputs and inputs the audible signal, or speaks and listens, on behalf of the cellular phone for the driver in the vehicle.

The driver of the vehicle, for example, can place a call and converse with a person without holding the cellular phone by using the remote communication apparatus disposed in the vehicle.

The conventional remote communication apparatus establishes a connection to a registered cellular phone based on an ID that identifies each cellular phone. This type of remote communication apparatus disposed in the vehicle requires a registration procedure before the user of the cellular phone actually uses the apparatus for answering the call. This registration procedure is not a problem for the user who regularly uses a same vehicle. However, the procedure becomes tedious when the user is asked to register the cellular phone everytime he/she drives a different vehicle equipped with this device. Registration procedure may also be followed by deletion procedure, when the user leaves the vehicle. This situation is typically observed for users in a company who arbitrarily use one of plural company owned vehicles.

The registration and deletion procedure of the cellular phone may be perceived as troublesome when the user of the cellular phone has to repeat the procedure many times.

### SUMMARY OF THE INVENTION

In view of the above problems, it is an object of the present invention to provide a remote communication apparatus having an intermediary function to a registered cellular phone through a wireless connection that is established in a simplified procedure.

According to the present invention, the remote communication apparatus wirelessly connects to the registered cellular phone within a connection area for providing an intermediary function. The remote communication apparatus further accommodates the non-registered cellular phone by reducing a transmission power for the wireless connection under an instruction of the user by a cellular phone independent input device.

In this manner, the remote communication apparatus authorizes the wireless connection with the non-registered cellular phone. That is, the reduced transmission power narrows the connection area for the non-registered cellular phone, and the non-registered cellular phone has to be in a close proximity of the remote communication apparatus. As a result, a connection to the non-registered cellular phone is prioritized to a connection to the registered cellular phone by a device independent (i.e., cellular phone independent) operation. That is, a simple, device independent operation enables the user to register the cellular phone to the remote communication apparatus for the intermediary function.

The intermediary function provided by the wireless connection is a function that receives and outputs a transmitted voice signal received by the cellular phone that is placing a call to another telephone as an audible signal, and inputs and sends the audible signal (i.e., voice) of the user of the cellular phone to another telephone through the wireless connection.

The registered cellular phone in this case indicates a cellular phone that is identified by the remote communication apparatus by an ID registered therein.

The remote communication apparatus may prioritize the wireless connection to the non-registered cellular phone to the wireless connection to the registered cellular phone based on an instruction from the user.

The remote communication apparatus may register the non-registered cellular phone in the connection area to prioritize it as the registered cellular phone.

The remote communication apparatus may register a first non-registered cellular phone that enters the connection area after receiving the user's instruction.

The remote communication apparatus may increase a transmission power of the wireless connection after registering the non-registered cellular phone.

The remote communication apparatus may prohibit the wireless connection to the cellular phone when an ignition switch of the vehicle is turned off. This is because the remote communication apparatus is installed in the vehicle and the device is intended for use in the vehicle.

The remote communication apparatus may delete the registration of the cellular phone when the ignition switch is turned off. In this manner, the user can save a process to delete the registration of the cellular phone.

The remote communication apparatus may authorize the wireless connection to the cellular phone while a button switch in an input device of the remote communication apparatus is pressed.

The remote communication apparatus may decrease the transmission power of the wireless connection while the button switch in the input device of the remote communication apparatus is pressed.

The remote communication apparatus may prohibit the wireless connection to the cellular phone when the wireless connection is interrupted.

The remote communication apparatus of the present invention is characterized by the input device that accepts the input of the user for authorizing the wireless connection to the non-registered cellular phone.

In this manner, a device independent operation (i.e., a cellular phone independent operation) on the input device of the wireless connection device authorizes the wireless connection from the remote communication apparatus to the cellular phone. Therefore, complication of the registration procedure for authorizing the wireless connection to the remote communication apparatus is decreased.

The remote communication apparatus of the present invention is further characterized by the function that prioritizes the wireless connection to the non-registered cellular phone over the wireless connection to the registered cellular phone based on closeness of the cellular phone to the remote communication apparatus. That is, the non-registered cellular phone is prioritized in terms of the wireless connection when a first distance from the non-registered cellular phone to the remote communication apparatus is shorter than a second distance from the registered cellular phone to the remote communication apparatus.

In this manner, complication of the registration procedure of the non-registered cellular phone is decreased. That is, the wireless connection to the registered cellular phone is switched to the wireless connection to the non-registered cellular phone only by bringing the non-registered cellular phone closer to the remote communication apparatus than the first distance, that is, closer to the remote communication apparatus than the registered cellular phone.

### BRIEF DESCRIPTION OF THE DRAWINGS

Other objects, features and advantages of the present invention will become more apparent from the following detailed description made with reference to the accompanying drawings, in which:

FIG. 1 shows an illustrative drawing of a telephone system with regard to an embodiment of the present invention;

FIG. 2 shows a block diagram of a remote communication apparatus;

FIG. 3 shows a flowchart of a narrow area mode registration program; and.

FIG. 4 shows a sequence chart of a communication procedure between the remote communication apparatus and a cellular phone.

### DETAILED DESCRIPTION OF THE PREFERRED EMBODIMENTS

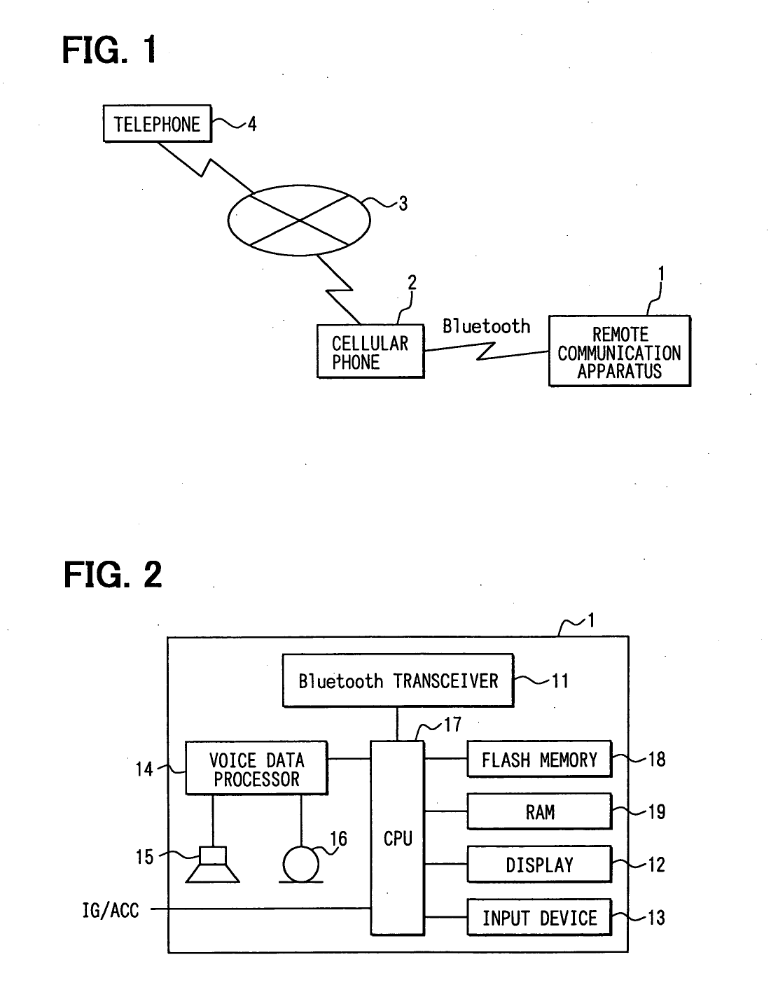

An embodiment of the present invention is explained with reference to the drawings. FIG. 1 shows a general scheme of a telephone system with regard to an embodiment of the present invention.

A remote communication apparatus 1 installed on a vehicle establishes a communication to a cellular phone 2 that is already registered to the remote communication apparatus 1. The remote communication apparatus 1 establishes a wireless connection to the cellular phone 2 by using a Bluetooth technology when the cellular phone 2 enters into a connection area of the remote communication apparatus 1.

The cellular phone 2 wirelessly transfers a call by another telephone 4 in a telephone system 3 to the remote communication apparatus 1 when the wireless connection with the remote communication apparatus 1 is being established. The remote communication apparatus 1 outputs an audible signal, i.e., voice, from a speaker. In addition, the remote communication apparatus 1 receives voice of an occupant of the vehicle by using a microphone and sends a voice signal wirelessly to the cellular phone 2. The voice signal is transferred from the cellular phone 2 to the telephone 4 through the telephone system 3. In this manner, the remote communication apparatus 1 intermediates the call between the cellular phone 2 and the telephone 4.

The remote communication apparatus 1 is illustrated as a block diagram in FIG. 2. The remote communication apparatus 1 includes a Bluetooth transceiver 11, a display 12, an input device 13, a voice data processor 14, a speaker 15, a microphone 16, a CPU 17, a flash memory 18, and a RAM 19. The flash memory 18 is a non-volatile writable memory medium that stores a registration data for the wireless connection.

The Bluetooth transceiver 11 controls the wireless connection to the cellular phone 2 or the like based on an instruction of the CPU 17. More practically, the Bluetooth transceiver 11 outputs a voice signal of another cellular phone 2 received by a Bluetooth antenna (not shown in the figure) to the CPU 17 after processing the voice signal according to a Bluetooth protocol including an amplification, a frequency conversion, a demodulation, an analog/digital conversion and the like. The Bluetooth transceiver 11 also outputs a signal to the Bluetooth antenna after processing an input from the CPU 17 according to the Bluetooth protocol including a digital/analog conversion, a modulation, the frequency conversion, the amplification and the like.

The Bluetooth transceiver 11 controls a transmission power of the wireless connection based on the instruction from the CPU 17. More practically, the transmission power is switched to either of a low power mode and a normal power mode (i.e., an output of the Bluetooth transceiver 11 is decreased from the normal power mode to the low power mode). The connection area of the Bluetooth transceiver 11 in the low power mode is narrower than that of the normal power mode.

The display 12 includes a liquid crystal display or the like, and displays output data from the CPU 17 on a display area.

The input device 13 includes a mechanical push switch or the like, a touch panel disposed on the display area and the like. The input device outputs a signal based on a user operation to the switches, the panel and the like.

The voice data processor 14 outputs an audible signal from the speaker 15 after it converts a digital voice signal from the CPU 17 to an analog form. The voice data processor 14 outputs the digital voice signal to the CPU 17 after it converts the analog form of sound, e.g., voice, into the digital voice signal.

The CPU 17 executes a program retrieved from the flash memory 18. The CPU 17 processes the signal from the Bluetooth transceiver 11, the input device 13 and the voice data processor 14 according to the executed program. The CPU 17 retrieves and writes information to the RAM 19 after processing the signal, outputs a transmission signal and a power control signal to the Bluetooth transceiver 11, and outputs the digital voice signal to the voice data processor 14. The CPU 17 controls the Bluetooth transceiver 11 for connection and disconnection to the cellular phone 2. The CPU 17 receives a signal from an IG/ACC switch to determine whether an ignition switch of the vehicle is ON or OFF.

The CPU 17 executes the program retrieved from the flash memory 18. The program includes a cellular phone registration program, a wireless connection control program, an intermediation program. The CPU 17 executes the wireless connection program to establish the wireless connection (i.e., a Bluetooth link) to the cellular phone 2 when the registered cellular phone 2 enters into the connection area of the remote communication apparatus 1 based on a registered priority. The CPU 17 executes the intermediation program when the remote communication apparatus 1 is wirelessly connected to the cellular phone 2. The CPU 17 controls intermediation between the remote communication apparatus 1 and the cellular phone 2 by executing the intermediation program.

The CPU 17 registers the cellular phone 2 in the following manner. The CPU 17 executes the cellular phone registration program under an instruction by a user. The CPU 17 stores an ID with a priority of the ID in the flash memory 18 when the user inputs those data from the input device 13. The input data is appended to a registration data in the flash memory 18. In this case, the ID identifies a cellular phone 2. The ID is associated to a predetermined priority when the user omits the input of the priority.

The CPU 17 controls the wireless connection in the following manner. The CPU 17 continuously executes the wireless connection control program. The CPU 17 sends a connection request signal from the Bluetooth transceiver 11 to the cellular phone 2. The cellular phone 2 responds to the connection request signal by sending a connection response signal to the remote communication apparatus 1 according to the Bluetooth protocol. The connection response signal includes identification information of the cellular phone 2.

The CPU 17 recognizes the cellular phone 2 as approaching when it receives the connection response signal through the Bluetooth transceiver 11.

The CPU 17 compares the identification information with the registration data in the flash memory 18, and determines whether the identification information is identified by the ID in the registration data when it recognizes that the cellular phone 2 is approaching to the remote communication apparatus 1.

The CPU 17 executes either of a first process and a second process when the identification information is identified by the ID in the registration data.

The first process is executed when there is no cellular phone 2 connected wirelessly to the remote communication apparatus 1. The first process includes establishing the wireless connection to the cellular phone 2 that newly enters into the connection area. Establishing the wireless connection indicates that the remote communication apparatus 1 and the cellular phone 2 are in communication wirelessly to accommodate and intermediate a call by using the remote communication apparatus 1 when the cellular phone 2 receives an incoming call.

The second process is executed when a cellular phone 2 is already connected to the remote communication apparatus 1. The second process includes comparison of the priority of the cellular phone 2 that the wireless connection already established to the remote communication apparatus 1 to the priority of another cellular phone 2 that is newly approaching to the device 1. The established wireless connection is continued when the priority of the established wireless connection is higher or the same as the priority of the approaching cellular phone 2. The established connection is disconnected and a new connection is established, i.e., the connection is switched, to the approaching cellular phone 2 when the priority of the established connection is lower than the priority of the approaching cellular phone 2.

The CPU 17 executes the intermediation program in the following manner. The CPU 17 continuously executes the intermediation program while the wireless connection to the cellular phone 2 is established.

The cellular phone 2 informs the CPU 17 of a reception of an incoming call by sending a reception signal to the CPU 17 through the wireless connection by using the Bluetooth transceiver 11. The CPU 17 sends a session start signal to start a communication session for the incoming call in response to the reception signal through the wireless connection under an instruction of the user for starting the session from the input device 13. The CPU 17 further receives a notice of telephone circuit establishment from the cellular phone 2 through the Bluetooth transceiver 11 when it actually starts the intermediation of the call between the cellular phone 2 and the telephone 4.

The CPU 17 informs the cellular phone 2 through the Bluetooth transceiver 11 that the user is placing a call to the telephone 4 when it receives a signal for placing the call from the input device 13. The CPU 17 receives a notice of telephone circuit establishment from the cellular phone 2 through the Bluetooth transceiver 11 when it actually starts the intermediation of the call between the cellular phone 2 and the telephone 4.

The intermediation of the call between the cellular phone 2 and the telephone 4 is more practically explained in the following manner. The cellular phone 2 transfers a voice data from the telephone 4 to the remote communication apparatus 1 through the wireless connection. The CPU 17 outputs the digital voice signal based on the voice data to the voice data processor 14 to convert the signal to an audible form, i.e., voice, for outputting it from the speaker 15. The voice of the occupant of the vehicle captured and processed by the microphone 16 and the voice data processor 14 is sent to the CPU 17 as a digital voice signal, and transferred to the cellular phone 2 through the wireless connection. The cellular phone 2 sends the signal to the telephone 4 through the telephone system 3. The call between the cellular phone 2 and the telephone 4 is intermediated by the remote communication apparatus 1 in the above-described manner.

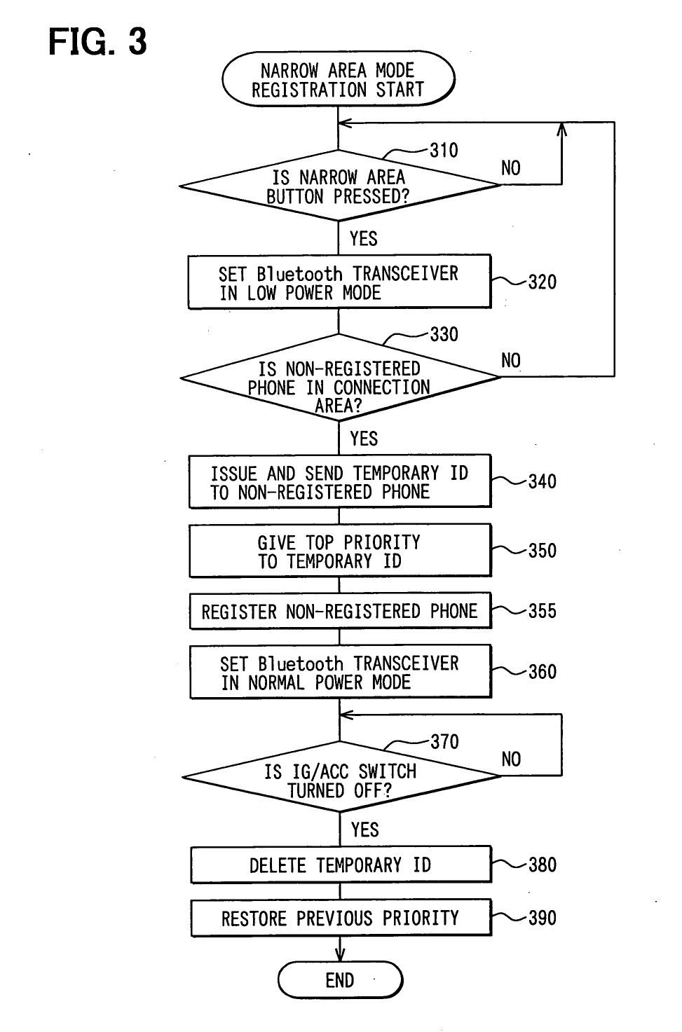

The CPU 17 executes a narrow area mode registration program in addition to the above-described programs. The narrow area mode registration program is continuously executed by the CPU 17. A flowchart of the narrow area mode registration program is shown in FIG. 3. The operation of the program is explained with reference to the flowchart in FIG. 3.

In step S310, a process of the program determines whether the push switch of the input device 13 is pressed or not. This push switch is designated as a narrow area button in the following description. The narrow area button is operated without inputting the identification information of the cellular phone 2. Therefore, the operation of the narrow area button is regarded as a cellular phone independent operation, or a device independent operation.

The operation of the narrow area button may be substituted by an operation of the touch panel. In this case, pressing the narrow area button corresponds to a touch in a predetermined area of the touch panel.

Step S310 is repeated until the narrow area button is detected as being pressed. The process executes step S320 when the narrow area button is pressed.

In step S320, the transmission power of the Bluetooth transceiver 11 is switched to the low power mode. More practically, the power control signal is sent to the Bluetooth transceiver 11 to decrease the transmission power.

In step S330, the process determines whether a non-registered cellular phone 2 is in the connection area of the remote communication apparatus 1. The non-registered cellular phone 2 is determined to be in the connection area when the CPU 17 receives the connection response signal from the cellular phone 2. The cellular phone 2 is determined as registered when the identification information in the connection response signal is identified by the ID in the registration data in the flash memory 18.

The process executes step S340 when the non-registered cellular phone 2 is within the connection area of the remote communication apparatus 1, and the process executes step S310 when the non-registered cellular phone 2 is not in the connection area.

In step S340, a temporary ID for the non-registered cellular phone 2 being determined in the connection area in step S330 is issued and sent to the cellular phone 2 as a part of a registration instruction signal.

The cellular phone 2 in the present embodiment stores the temporary ID as the identification information of the cellular phone 2 in the registration instruction signal by using a memory medium on the cellular phone 2. The cellular phone 2 responds to the connection request signal from the remote communication apparatus 1 by sending the connection response signal including the temporary ID until it deletes the temporary ID from the memory medium.

In step S350, the process gives the temporary ID a top priority. More practically, the priority given to the registered cellular phone 2 in the registration data in the flash memory 18 is changed so that the priority given to the temporary ID surpasses any other priority in the registration data.

The priority of the temporary ID may be determined to be a greater value than any other priority value of the registered cellular phone 2.

In step S355, the cellular phone 2 being determined to be within the connection area in step S330 is registered. More practically, the temporary ID determined in step S340 is associated with the priority determined in step S350, and is appended to the registration data in the flash memory 18.

In step S360, the transmission power of the Bluetooth transceiver 11 is increased to the normal power mode. More practically, the power control signal is sent to the Bluetooth transceiver 11 to increase the transmission power to a level of the normal power mode.

In step S370, a state of the IG/ACC switch is determined based on a signal from the IG/ACC switch. Step S370 is repeated while the switch is not determined as OFF. The process proceeds to step S380 when the switch is determined as OFF.

In step S380, the temporary ID of the cellular phone 2 being determined within the connection area in step S330 is deleted. More practically, the temporary ID and the priority stored in the flash memory 18 in step S355 is deleted. Further, a delete instruction signal for deleting the temporary ID is sent to the cellular phone 2 that is identified by the temporary ID.

The cellular phone 2 in the present embodiment deletes the temporary ID from the memory medium upon receiving the delete instruction signal.

In step S390, the priority of the cellular phone 2 is restored to a state before registration of the temporary ID. More practically, change to the priority of the registered cellular phone 2 is cancelled and a previous priority is used again. Execution of the narrow area mode registration program ends after execution of step S390.

The narrow area mode registration program allows the Bluetooth transceiver 11 to decrease the transmission power in the low power mode while the narrow area button is being pressed (step S310). Then, the CPU 17 further executes the following steps when the cellular phone 2 enters into the connection area (step S330) while the narrow area button is pressed. That is, the CPU 17 issues the temporary ID for a non-registered cellular phone 2 and sends the temporary ID to the cellular phone 2 by sending the registration instruction signal (step S340). The temporary ID has the top priority in the registration data (step S355).

The transmission power of the Bluetooth transceiver 11 is increased to the level of the normal power mode after registration of the temporary ID of the non-registered cellular phone 2. The non-registered cellular phone 2 is the first cellular phone 2 that enters the connection area after the narrow area button is pressed.

The registration is deleted (step S380) when the IG/ACC switch is turned off (step S370) and the priority is restored (step S390).

Operation of remote communication apparatus 1 including registration of the cellular phone 2, establishment of the wireless connection, intermediation of a call and registration of narrow area mode is shown as an example in the following description. The operation is under control of the program being executed by the CPU 17.

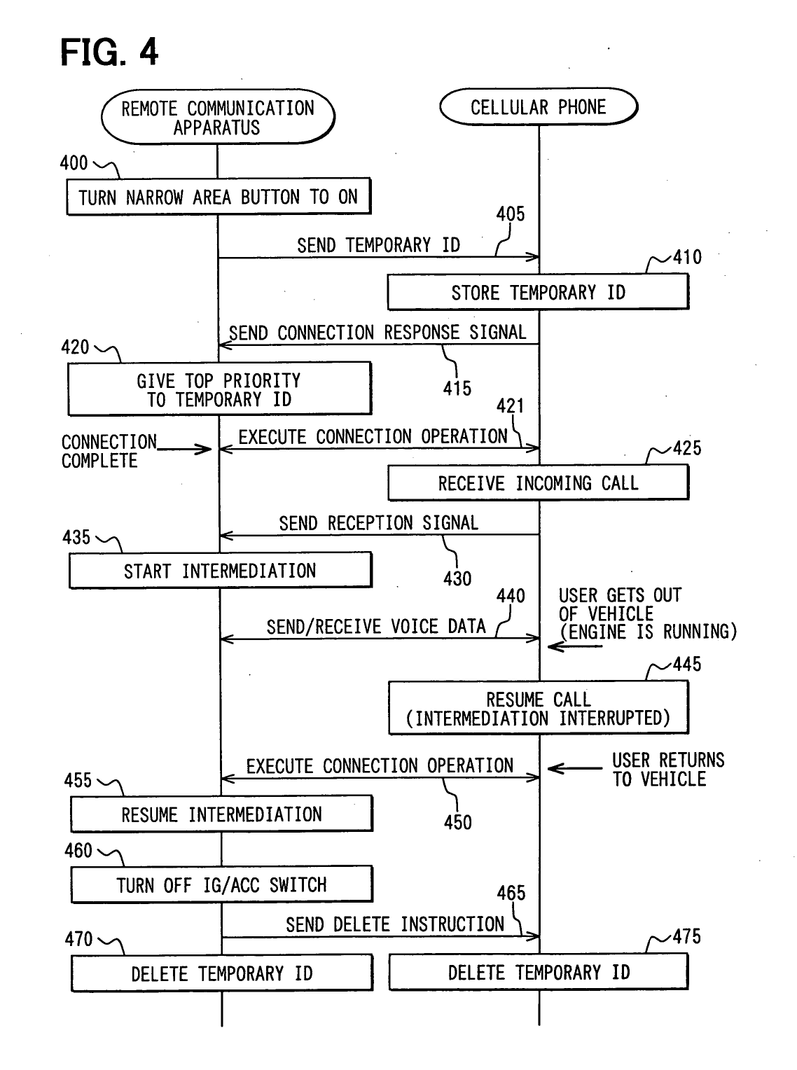

Steps in the operation taken by the remote communication apparatus 1 to accommodate a cellular phone 2 in the example are sequentially shown in FIG. 4.

The narrow area button on the remote communication apparatus 1 is pressed when the non-registered cellular phone 2 approaches to the device 1 within the connection area (e.g., within 30 cm from the apparatus 1) of the low power mode in the above description (step S400).

The device 1 determines a temporary ID for the cellular phone 2 and sends it to the cellular phone 2 together with the registration instruction signal in step S340 after determining steps S310 and S330 in FIG. 3 as YES (signal Sig405).

The cellular phone 2 receives the registration instruction signal and stores the temporary ID in the memory medium (step S410), and sends back the connection response signal including the temporary ID to the device 1 (signal Sig415).

The Bluetooth transceiver 11 gives the cellular phone 2 a top priority in terms of the wireless connection as described in steps S355 and S360 in FIG. 3 (step S420).

Then, the Bluetooth transceiver 11 establishes the wireless connection to the cellular phone 2 by executing the wireless connection control program based on the connection response signal and the temporary ID. The remote communication apparatus 1 and the cellular phone 2 exchange necessary information for establishing the wireless connection to each other in plural times of connection operation steps (signal Sig421).

The cellular phone 2 sends the reception signal to the remote communication apparatus 1 (signal Sig430) when the cellular phone 2 has an incoming call (step S425).

The remote communication apparatus 1 starts intermediation of the call by executing the intermediation program based on reception of the reception signal (step S435), and the call is intermediated by exchanging the voice data with the cellular phone 2 through the wireless connection of the Bluetooth link (signal Sig440).

The user of the cellular phone 2 placing the call may get out of the vehicle while the engine is still running (i.e., the IG/ACC switch is ON). In this case, intermediation of the call is interrupted when the cellular phone 2 leaves the connection area of the wireless connection, because a radio wave from the remote communication apparatus 1 in the normal power mode does not reach the cellular phone 2. That is, the cellular phone 2 resumes the call independently from the remote communication apparatus 1 when the cellular phone 2 is out of the wireless connection area of the remote communication apparatus 1 (step S445).

The intermediation of the remote communication apparatus 1 is re-established by executing the wireless connection control program when the user of the cellular phone 2 returns to an inside of the vehicle (i.e., returns to the connection area). In this case, the remote communication apparatus 1 tries to re-connect to the cellular phone 2 because the cellular phone 2 stays in the top priority. The wireless connection between the apparatus 1 and the cellular phone 2 is re-established through exchanging necessary information for the wireless connection (signal Sig450).

Then, the established wireless connection is used for intermediation of the call by the intermediation program (step S455).

Further, the remote communication apparatus 1 sends the delete instruction signal (signal Sig465) to the cellular phone 2 based on the process in step S380 in FIG. 3 when the IG/ACC switch of the vehicle is turned off by the user (step S460). The remote communication apparatus 1 deletes the temporary ID from the flash memory 18 (step S470). The cellular phone 2 also deletes the temporary ID from the memory medium upon receiving the instruction (step S475).

The remote communication apparatus 1 having the intermediation function for the registered cellular phone 2 in the connection area exclusively accommodates the non-registered cellular phone 2 by issuing the temporary ID when the non-registered cellular phone 2 enters into the connection area that is narrowed while the narrow area button is being pressed by the user. In this manner, the wireless connection to the non-registered cellular phone 2 is accommodated by the device independent operation. Therefore, complicated operation for registration is eased by the remote communication apparatus 1.

The remote communication apparatus 1 may be used for intermediation of the call to the registered cellular phone 2 in the connection area of the wireless connection in the normal power mode. The device 1 may also be used for intermediation of the call to the non-registered cellular phone 2 in the connection area of the wireless connection in the low power mode.

The remote communication apparatus 1 prioritizes the cellular phone 2 having the temporary ID to other cellular phone 2 in terms of the wireless connection for intermediation of the call.

The CPU 17 in the embodiment described above serves as a power control means by executing steps 320 and 360 shown in FIG. 3.

The CPU 17 serves as a authorization means by executing steps 340 and 355 shown in FIG. 3.

The CPU 17 serves as a priority control means by executing step 350 shown in FIG. 3.

The remote communication apparatus 1 has the connection area corresponding to the first distance in the normal power mode, and the connection area corresponding to the second distance in the low power mode.

Although the present invention has been fully described in connection with the preferred embodiments thereof with reference to the accompanying drawings, it is to be noted that various changes and modifications will become apparent to those skilled in the art.

For example, the remote communication apparatus 1 wirelessly connects to the first cellular phone 2 by issuing the temporary ID. However, the remote communication apparatus 1 may wirelessly connect to a plurality of the cellular phones 2 in the connection area.

Further, the remote communication apparatus 1 may delete the temporary ID of the cellular phone 2 instead of keeping the ID in the memory when wireless connection is interrupted. That is, the remote communication apparatus 1 may prohibit the wireless connection for intermediation for the cellular phone 2 based on the temporary ID by deleting the temporary ID when the wireless connection to the cellular phone 2 is interrupted.

Such changes and modifications are to be understood as being within the scope of the present invention as defined by the appended claims.

1. A remote communication apparatus for a wireless connection to a registered cellular phone in a connection area comprising:
an input device for accepting an input of a user that is independent of the cellular phone;
power control means for controlling an output for the wireless connection based on the user input from the input device; and
authorization means for authorizing a wireless connection for intermediation to a non-registered cellular phone by registering the non-registered cellular phone based on the user input from the input device.

2. The remote communication apparatus of claim 1 further comprising:
priority control means for giving a higher priority to the wireless connection for intermediation to the non-registered cellular phone than a priority to the wireless connection to a registered cellular phone based on the input of the user from the input device.

3. The remote communication apparatus of claim 2,
wherein the authorization means allows the wireless connection to the non-registered cellular phone by registering the non-registered cellular phone that enters into a connection area as a newly-registered cellular phone, and
the priority control means gives the higher priority to the wireless connection to the newly-registered cellular phone than the priority to the wireless connection to the registered cellular phone.

4. The remote communication apparatus of claim 3,
wherein the authorization means registers only a first non-registered cellular phone that enters into the connection area after receiving the input of the user from the input device.

5. The remote communication apparatus of claim 3;
wherein the power control means increase the power output for wireless connection upon receiving registration of the non-registered cellular phone from the authorization means.

6. The remote communication apparatus for use in a vehicle of claim 5,
wherein the remote communication apparatus is used in a vehicle, and
the wireless connection for intermediation to the cellular phone authorized by the authorization means is prohibited when an ignition switch of the vehicle is turned off.

7. The remote communication apparatus of claim 1,
wherein the remote communication apparatus is used in a vehicle, and
the registration of the cellular phone by the authorization means is deleted when an ignition switch of the vehicle is turned off.

8. The remote communication apparatus of claim 1,
wherein the input device has a button to be pressed by the user, and
the authorization means allows the wireless connection for intermediation to the non-registered cellular phone while the button of the input device is pressed by the user.

9. The remote communication apparatus of claim 1,
wherein the input device has a button to be pressed by the user; and
the power control means decreases the output of the remote communication apparatus while the button of the input device is pressed by the user.

10. An automotive remote communication apparatus having a wireless connection to a registered cellular phone comprising;
an input device for accepting an input from a user, and
an authorization means for authorizing a wireless connection for intermediation to a non-registered cellular phone based on the input from the input device.

11. An automotive remote communication apparatus for intermediation having a wireless connection to a registered cellular phone in a first connection area comprising;
an authorization means for authorizing the wireless connection for intermediation to a non-registered cellular phone,
wherein the authorization means authorizes the wireless connection to the non-registered cellular phone that enters a second connection area, and
the second connection area is contained in the first connection area.

12. The remote communication apparatus of claim 1,
wherein the wireless connection to the cellular phone authorized by the authorization means is prohibited when the wireless connection is interrupted.
